(19) United States
(12) Patent Application Publication
(10) Pub. No.: US 2004/0023686 A1
(43) Pub. Date: Feb. 5, 2004

(54) Method of and apparatus for outputting a picture file

(75) Inventors: John J. King, Wheaton, IL (US); Christina J. King, Wheaton, IL (US)

Correspondence Address: John J. King, 1481 Cantigny Way, Wheaton, IL, 60187, US

(73) Assignee: LAVAFLOW, LLP, Wheaton, IL (US)

(21) Appl. No.: 10/631,255

(22) Filed: Jul. 31, 2003

Related U.S. Application Data
(60) Provisional application No. 60/399,843, filed on Jul. 31, 2002.

(51) Int. Cl. H04B 1/034

(52) U.S. Cl. 455/550.1; 455/95

(57) ABSTRACT

A cellular telephone capable of transmitting a picture is disclosed. The cellular telephone comprises a digital camera capturing the picture; a control circuit coupled to the digital camera, the control circuit enabling the storage of the picture; a memory coupled to the control circuit; and a border stored in memory, the border being applied to the picture to surround the picture. A method of displaying a picture on a cellular telephone is also disclosed. The method comprises the steps of providing a digital camera on the cellular telephone for capturing a picture; storing a border in a memory of the cellular telephone; and coupling a border to a picture.

### CLAIM FOR PRIORITY

Applicants claim priority on co-pending U.S. provisional application 60/399,843, entitled METHOD OF AND APPARATUS FOR OUTPUTTING A PICTURE FILE and filed on Jul. 31, 2002 by Applicants of the present invention and assigned to the assignee of the present invention.

### FIELD OF THE INVENTION

This disclosure relates generally to wireless communication devices, networks, and services, and more particularly to devices, networks, and methods for outputting a picture file from a wireless communication device.

### BACKGROUND OF THE INVENTION

Since the discovery of two-way radios, wireless communications has continuously evolved. Over the last two decades, cellular telephones have become increasingly popular and widely used. As the number of users has increased, the rates for airtime have decreased, further expanding the market of users of cellular telephones. However, the increasing number of users of cellular telephones and the lower rates for services have put financial pressure on wireless service providers. In particular, wireless service providers have had to invest in new networks to increase capacity to handle the additional users, while their profit margins have decreased due to competition leading to reduced rates for service.

In order to address capacity and profit margin issues caused by the increased number of subscribers and the reduced margins on services, wireless service providers have adopted digital cellular telephone networks, such as TDMA, CDMA or GSM networks. Such networks not only have enabled more users on a network, but also have enabled additional features, such as email, short messaging service (SMS), enhanced messaging service (EMS), or multimedia messaging service (MMS) messaging, which are well known in the art of cellular communications. More importantly, GPRS, EGDE, CDMA2000 and their derivatives, or other advanced networks have enabled a considerable increase in data or information content provided to wireless communication devices. GPRS is generally a feature of current digital cellular telephone networks that enables an “always-on” service for wireless communication devices. That is, GPRS enables the display of data or information on a cellular telephone instantaneously and continuously in a fashion which is similar to a computer user on the Internet using a T-1 line, which is well known in the art.

Similarly, in order to increase the sale of cellular telephones, manufacturers and wireless service providers have been promoting new cellular telephones with color displays, also called color screens. Such new cellular telephones are intended to increase sales both through the sale of phones to new subscribers or replacement phones for existing subscribers. The color displays on the new cellular telephones enable the transfer of new types of data, such as pictures or photographs.

However, while such phones are being offered, no user interfaces, networks or services are providing features which can both increase the use of the wireless communication device or increase revenues for service providers. That is, while such improvements as color displays on cellular telephones and new networks such as GPRS or CDMA 2000 and their derivatives exist, conventional cellular telephones and services provided by wireless service providers are significantly deficient in providing new content which is adapted to be displayed by a color display on a cellular telephone or transmitted on an “always-on” network, such as a GPRS network. Similarly, the user interfaces of such conventional cellular telephones are not adapted to display the new content which could be provided to color displays on cellular telephones. For example, many cellular telephones incorporate or are adapted to receive a digital camera. However, such cellular telephones do not have user interfaces which make the downloading and printing of picture files easy. Further, printing equipment for printing picture files are not adapted to easily accept picture files from cellular telephones.

Accordingly, there is a need for a wireless communication device for downloading picture files to printing equipment.

There is a further need for improved printing equipment for printing picture files downloaded from a cellular telephone.

There is a further need for improved services for printing picture files stored on cellular telephones.

### BRIEF DESCRIPTION OF THE DRAWINGS

FIG. 1 is a block diagram of a wireless communication network according to the present invention;

FIG. 2 is a block diagram of a wireless communication network according to an alternate embodiment of the present invention;

FIG. 3 is a block diagram of an alternate embodiment of a wireless communication network according to the present invention;

FIG. 4 is a timing diagram showing a method for generating a printed photo by the entities in the wireless communication network of FIG. 3 according to the present invention;

FIG. 5 is a timing diagram showing a method for generating a printed photo by the entities in the wireless communication network of FIG. 3 according to an alternate embodiment of the present invention;

FIG. 6 is a timing diagram showing a method for generating a printed photo by the entities in the wireless communication network of FIG. 3 according to an alternate embodiment of the present invention;

FIG. 7 is a timing diagram showing a method for generating a printed photo by the entities in the wireless communication network of FIG. 3 according to an alternate embodiment of the present invention;

FIG. 8 is a timing diagram showing a method for generating a printed photo by the entities in the wireless communication network of FIG. 3 according to an alternate embodiment of the present invention;

FIG. 9 is a timing diagram showing a method for generating a printed photo by the entities in the wireless communication network of FIG. 3 according to an alternate embodiment of the present invention;

FIG. 10 is a timing diagram showing a method for generating a printed photo by the entities in the wireless communication network of FIG. 3 according to an alternate embodiment of the present invention;

FIG. 11 is a block diagram of a wireless communication device according to the present invention;

FIG. 12 is a block diagram of printing equipment according to the present invention;

FIG. 13 is a top plan view of a wireless communication device when closed according to the present invention;

FIG. 14 is a side view of the wireless communication device of FIG. 13 when open according to the present invention;

FIG. 15 is a top plan view of the wireless communication device of FIG. 13 when opened according to the present invention;

FIG. 16 is a tree diagram showing an example of a portion of a photo menu according to the present invention;

FIG. 17 is an example of a display of a wireless communication device showing an import feature according to the present invention;

FIG. 18 is an example of a display of a wireless communication device showing a create feature according to the present invention;

FIG. 19 is an example of a display of a wireless communication device showing a postcard feature according to the present invention;

FIG. 20 is an example of a display of a wireless communication device showing a print feature according to the present invention;

FIG. 21 is an example of a display of a wireless communication device showing a send feature according to the present invention;

FIG. 22 is an example of a display of a wireless communication device showing a payment feature according to the present invention;

FIG. 23 is an example of a postcard generated according to the present invention;

FIG. 24 is a flowchart showing a method of outputting a picture file from a cellular telephone according to the present invention;

FIG. 25 is a flowchart showing a method of outputting a picture file from a digital camera according to an alternate embodiment of the present invention;

FIG. 26 is a flowchart showing a method of outputting a picture file and printing instructions to printing equipment according to an alternate embodiment of the present invention;

FIG. 27 is a flowchart showing a method of outputting a picture file by way of a removable memory according to an alternate embodiment of the present invention;

FIG. 28 is a flowchart showing a method of outputting a picture file and graphics according to an alternate embodiment of the present invention;

FIG. 29 is a flowchart showing a method of outputting a picture file associated with a coupon according to an alternate embodiment of the present invention;

FIG. 30 is a flowchart showing a method of outputting a picture file manipulated on a cellular telephone according to an alternate embodiment of the present invention;

FIG. 31 is a flowchart showing a method of outputting a picture file taken by and manipulated on a cellular telephone according an alternate embodiment of the present invention;

FIG. 32 is a flowchart showing a method of outputting a picture file wirelessly transmitted to printing equipment according to an alternate embodiment of the present invention;

FIG. 33 is a flowchart showing a method of outputting a picture file provided from a digital camera to a cellular telephone according to an alternate embodiment of the present invention;

FIG. 34 is a flowchart showing a method of outputting a picture file for which a payment was provided to printing equipment according to an alternate embodiment of the present invention;

FIG. 35 is a flowchart showing a method of outputting a picture file printed on a postcard according to an alternate embodiment of the present invention;

FIG. 36 is a flowchart showing a method of outputting a picture file on a postcard generated on a cellular telephone according to an alternate embodiment of the present invention;

FIG. 37 is a flowchart showing a method of outputting a picture file in response to a short range signal provided to a cellular telephone according to an alternate embodiment of the present invention; and

FIG. 38 is a flowchart showing a method of outputting a picture file in response to a signal from a wireless communication network according to an alternate embodiment of the present invention.

### DETAILED DESCRIPTION

The present disclosure provides numerous unique and novel features, user interfaces, services, communication networks, wireless communication devices, and revenue-generating business methods related to downloading picture files from wireless communication devices. Unlike conventional wireless communication devices, such as cellular telephones or pagers, which rely primarily on the transmission of voice or simple data respectively, the methods and devices of the present disclosure enable the transmission and/or printing of picture files. In particular, the present disclosure describes wireless communication devices, preferably having at least one color displays, which display information content, such as picture files, text, or advanced picture content, from a wireless service provider.

For purposes of this disclosure, a wireless communication device is any portable radio frequency (RF) communication device enabling bi-directional communication, such as a cellular telephone, pager, or combined cellular telephone/personal digital assistant. Because such devices are easily transportable and accessible by a user in any situation, a user can frequently and conveniently benefit from the advanced picture content or other information. In the category of wireless communication devices, such devices could be separated into wireless data communication devices, such as pagers, wireless voice communication devices, such as cellular telephones, or wireless voice/data communication devices, which are the most common and include, for example, digital cellular telephones, PCS telephones or other wireless telephony devices having data capabilities, such as email, SMS, EMS or MMS. In contrast, portable or laptop computers that can be adapted to enable wireless communication or PDAs that merely receive wireless data, would not be considered wireless communication, devices, but rather portable computers.

Advanced picture content refers to the display of one or more picture files using display functions, such as screensavers, slide shows, location-based information, streaming videos, the display of information related to picture files, or both. A picture files means any type of icon, graphic, digital image or digital photograph, design, background screen, etc., stored in any type of standard or proprietary format, such as JPEG, GIFF, TIFF, etc. Similarly, the present disclosure describes networks for enabling the transmission picture files to or from a wireless communication device. While a number of specific embodiments are shown, it is contemplated that a particular feature(s) of one specific embodiment could be incorporated on another embodiment.

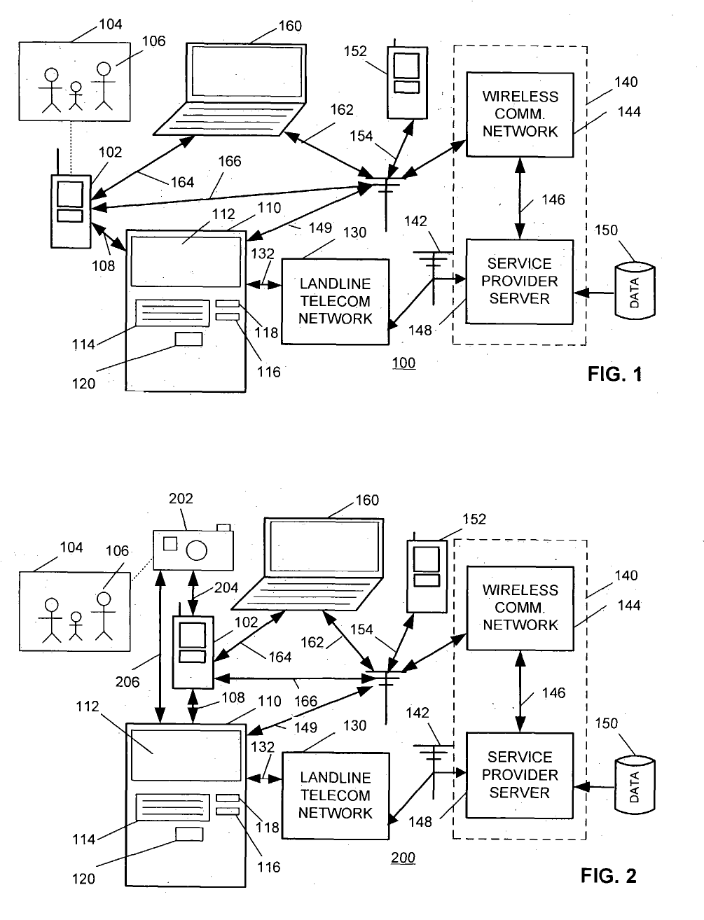

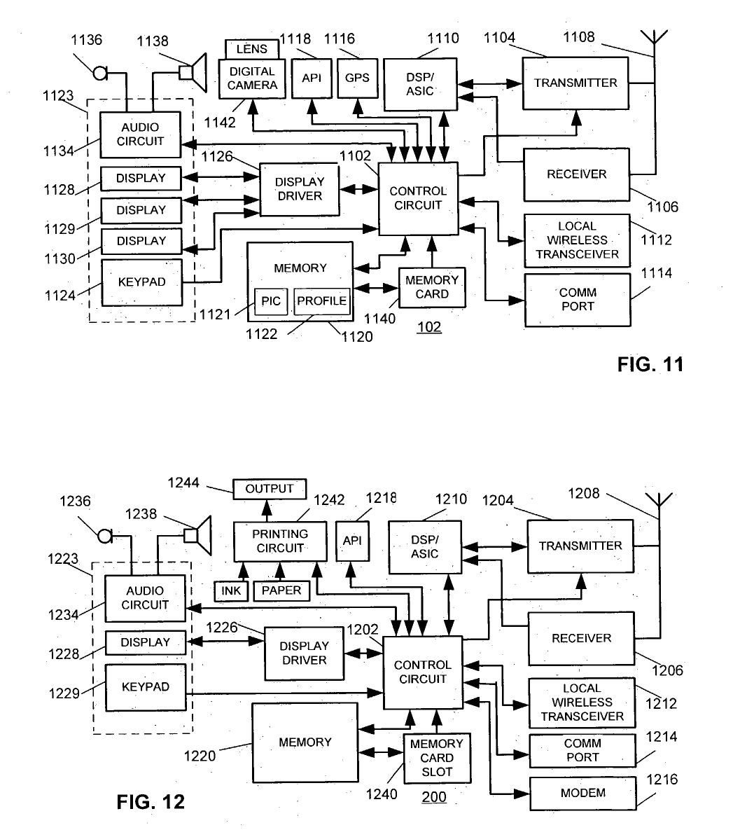

Turning now to FIG. 1, a block diagram shows a wireless communication network according to the present invention. In particular, wireless communication network 100 comprises a wireless communication device 102, which could be, for example, a cellular telephone or other wireless communication device, and will be described in more detail in reference to FIG. 11. The wireless communication device 102 preferably comprises a digital camera, as shown taking a picture file of a background 104 and subjects 106. Wireless communication device 102 is coupled by a communication link 108 to printing equipment 110. The printing equipment preferably comprises a display 112, a user interface 114, such as a keypad, a communication interface 116, a payment interface 118, and an output 120 which would receive printed photographs from picture files. The communication interface 116 could comprise any type of wired or wireless communication interface. For example the communication interface could be a short range wireless communication interface, such as bluetooth, I.E.E.E. 802.11, or some other short range communication protocol. Alternatively, the communication interface could be a wide area communication link, such as a cellular communication network. Further, the communication interface could be a wired communication interface, such as a serial interface operating on a conventional protocol such as RS-232 or some proprietary protocol. The printing equipment 110 could be, for example, a kiosk in a shopping mall or printing equipment at a photography shop. The printing equipment 110 will be described in more detail in reference to FIG. 12

The printing equipment 110 is also coupled to a landline telecommunications network 130 by way of a communication link 132. The communication link 132 could be any wired or wireless link for coupling the printing equipment to the telecommunications network. Alternatively, the printing equipment 110 could be coupled to a communication network 140 by way of another communication link 142. The communication network 140 preferably comprises a wireless communication network 144 which is coupled by a communication link 146 to a service provider server 148. The service provider server 148 could be associated with the wireless communication network 144, or could stand alone. Alternatively, the printing equipment 112 could be coupled directly to be communication network 140 by way of a communication link 149.

The wireless communication device 102 is also preferably coupled to a separate wireless communication device 152 by a communication link 154. Further, both the wireless communication device 102 and the separate wireless communication device 152 could be coupled to a computer, such as a laptop computer 160, by way of a communication link 162 or a communication link 164. As will be described in more detail in reference to remaining figures, the wireless communication device 102 will be able to communicate with the other devices in the communication network, and provide various outputs to the other device.

Turning now to FIG. 2, a wireless communication network according to an alternate embodiment of the present invention in shown. According to this embodiment, a digital camera 202 takes a picture of the background 104 and subjects 106. The digital camera 202 preferably comprises one or more of the communication interfaces of the wireless communication device 102 shown in FIG. 11, thereby enabling the digital camera to communicate with the wireless communication device. According to the embodiment of FIG. 2, the communication network enables the transmission of a picture file taken by a digital camera and transferred to a cellular telephone adapted to display and/or transmit the picture file.

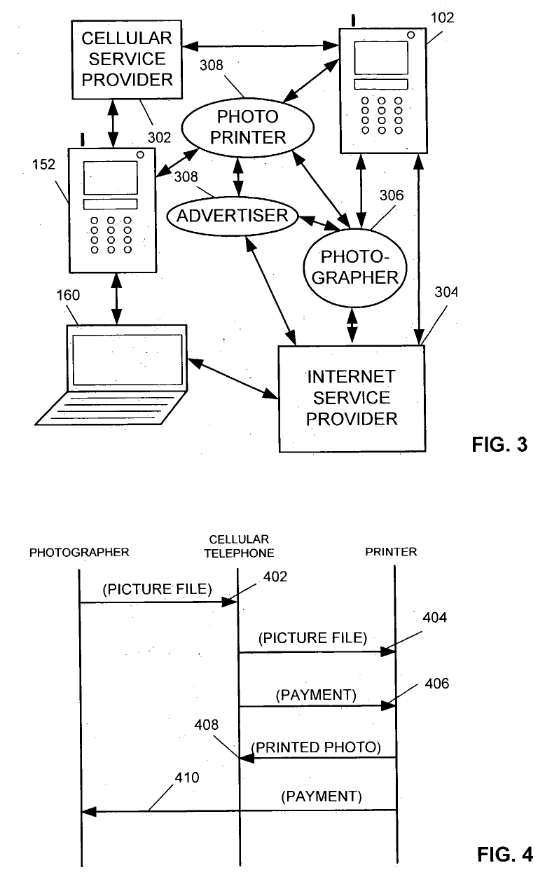

Turning now to FIG. 3, a block diagram shows an alternate embodiment of a wireless communication network according to the present invention. In particular, the wireless communication device 102 is capable of communicating with a separate wireless communication device 152 and the laptop computer 160 by way of a cellular service provider 302 and/or an Internet service provider 304. The wireless communication device 102 is also adapted to communicate with a photographer 306 and a photo printer 308. The photographer 306 and the photo printer 308 are generally adapted to communicate with an advertiser 308. The interaction of the elements of FIG. 3 would be described in more detail in reference to remaining figures.

Turning now to FIG. 4, a timing diagram shows a method for generating a printed photo according to the present invention. As will become apparent, the timing diagrams shown in FIGS. 4-10 can be applied to any of the communication networks shown in FIGS. 1-3. In particular, a picture file is provided from a photographer to a cellular telephone at a step 402. The picture file is then downloaded from the cellular telephone to a printer at a step 404. The printer could be any entity or device which converts a digital image or picture file to a printed picture, as is well-known in the art. For example, the printer could be a stand-alone printer coupled to the home computer that is adapted to print picture files, or printing equipment owned by a professional printer or photographic developer. A payment is also provided from the cellular telephone to the printer at a step 406. Preferably, the payment is provided by way of electronic funds transfer wirelessly authorized by the cellular telephone to the printer. Alternatively, the cellular telephone could be coupled to the printer by a cable or some other wireline connection. A printed photo is then provided to be user of the cellular telephone at a step 408. Finally, the printer provides a payment to the photographer who provided the picture to the cellular telephone. That is, because the photographer enabled the downloading of the picture file to the cellular telephone resulting in the printing of the photograph, the printer provides a percentage of his payment to the photographer.

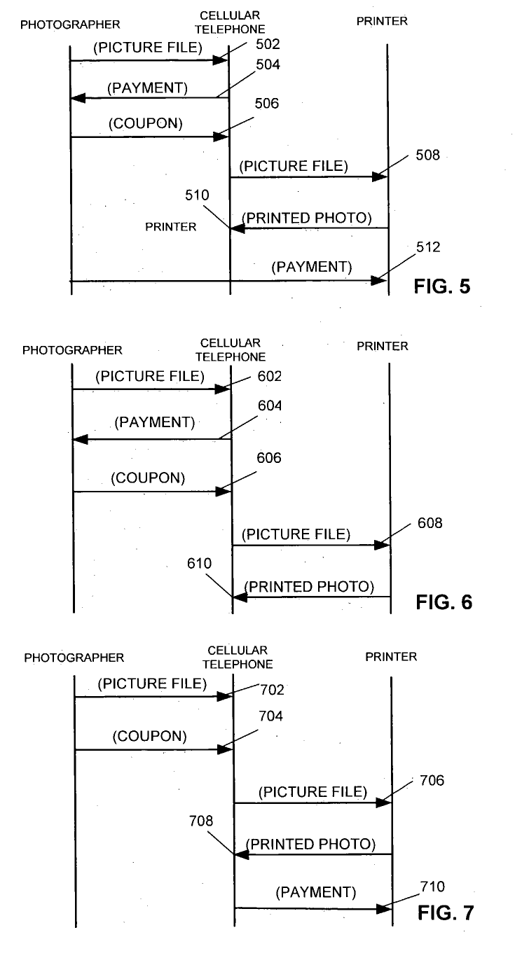

Turning now to FIG. 5, a timing diagram shows a method for generating a printed photo according to an alternate embodiment of the present invention. In particular, a picture file is provided from a photographer to a cellular telephone at a step 502. A payment is then provided from the user of the cellular telephone to the photographer at a step 504. A coupon is then provided from the photographer to the cellular telephone at a step 506. Preferably, the coupon is a wireless coupon transferred to and stored in the memory of the cellular telephone. The picture file is then transferred from the cellular telephone to a printer at a step 508. A printed photo is then provided to the user of the cellular telephone at a step 510. Finally, a payment is made from the photographer to the printer at a step 512 if the printer is an independent business, such as a printing shop or other vendor. Alternatively, rather than the photographer paying the printer for providing the printed photo to the user of the cellular telephone, the payment could be made from the cellular telephone to the printer, whereby the printer can provide a portion of the payment back to the photographer for providing the picture file to the cellular telephone.

Turning now to FIG. 6, a timing diagram shows a method for generating a printed photo according to an alternate embodiment of the present invention. In particular, a picture file is provided from a photographer to cellular telephone at a step 602. The cellular telephone makes a payment at a step 604 to the photographer. The payment is preferably provided by a wireless communication link between the cellular telephone and the photographer for the services for providing the picture file to the cellular telephone. The photographer can then provide a coupon to the cellular telephone at a step 606. The picture file is then provided from the cellular telephone to a printer at a step 608 with the coupon. Finally, the printed photo is then provided from the printer to the user of the cellular telephone at a step 610.

Turning now to FIG. 7, a timing diagram shows a method for generating a printed photo according to an alternate embodiment of the present invention. In particular, a picture file is provided from a photographer to the cellular telephone at a step 702. A coupon is also provided to the cellular telephone at a step 704. The picture file is then downloaded from the cellular telephone to a printer at a step 706. A printed photo is then provided from the printer to the user of the cellular telephone at a step 708. Finally, a payment is made from the cellular telephone to the printer at a step 710.

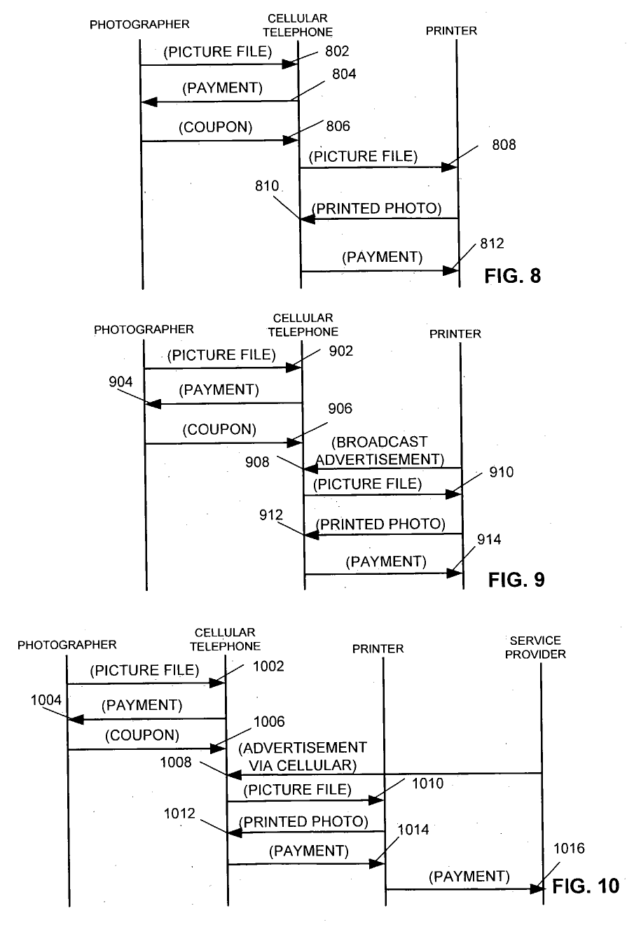

Turning now to FIG. 8, a timing diagram shows a method for generating a printed photo according to an alternate embodiment of the present invention. In particular, a picture file is provided from the photographer to the cellular telephone at a step 802. A payment is then made from the cellular telephone to the photographer at a step 804. A coupon is preferably provided from the photographer to the cellular telephone at a step 806. The picture file is then provided from the cellular telephone to a printer at a step 808 with the coupon. The, printed photo is then provided from the printer to the user of the cellular telephone at a step 810. Finally, a payment is provided from the cellular telephone to the printer at a step 812. The payment is preferably a reduced amount based upon the coupon provided at the step 806.

Turning now to FIG. 9, a timing diagram shows a method for generating a printed photo according to an alternate embodiment of the present invention. In particular, a picture file is provided from a photographer to the cellular telephone at a step 902. A payment is then made from the cellular telephone to the photographer at a step 904. A coupon is preferably provided from the photographer to the cellular telephone at a step 906. A broadcast advertisement is then preferably made from the printer at a step 908. The broadcast advertisement could be any type of short-range wireless communication signal which could be received by the cellular telephone. Preferably, the strength of the short-range wireless indication signal would determine the range within which the cellular telephone would receive the signal. Accordingly, the user of the cellular telephone could easily find the printer. The broadcast advertising could also provided a general “Map” or directions to the printer. The picture file would then be provided at a step 910. The printed picture would then be provided to the user at a step 912 in return for a payment at a step 914.

Turning now to FIG. 10, a timing diagram shows a method for generating a printed photo according to an alternate embodiment of the present invention. In particular, a picture file is provided from a photographer to the cellular telephone at a step 1002. A payment is could then be made from the cellular telephone to the photographer at a step 1004. A coupon is preferably provided to the cellular telephone at a step 1006. A service provider then provides an advertisement via cellular to the cellular telephone at a step 1008. The advertisement is preferably a directed advertisement based upon the location of the cellular telephone relative to the printer. That is, the service provider will preferably be able to determine the location of the cellular telephone, as described in the specification. Therefore, the service provider could provide specific instructions for the user of the cellular telephone to find the printer. The picture file is then preferably provided from the cellular telephone to the printer at a step 1010. A printed photo is then provided from the printer to the user of the cellular telephone at a step 1012. A payment is then made from the cellular telephone to the printer at a step 1014. Finally, a payment is then made from the printer to the service provider at a step 1016 for directing the cellular telephone to the printer.

In the timing diagrams shown in FIGS. 4-10, it is contemplated that all of the transactions (i.e. the transfer of picture files, coupons, and payments,) are made by a a wireless link, such as a short-range link or a wide area link as described in reference to FIGS. 1-3. Alternatively, the transactions could be electronic transactions, but enabled by a wide link, such as a landline link, or a serial communication link on a wired connection between the cellular telephone and the photographer or printer. It is also contemplated that the photographer and the printer could be unmanned. That is, the “photographer” could be a kiosk or photo center that is adapted to take picture in response to the subjects interaction with a kiosk. Similarly, the printer could be a kiosk having printing equipment. Finally, is contemplated that the cellular telephone and printer could be the wireless communication device 102 and the printing equipment 200, respectively.

Turning now to FIG. 11, a block diagram of the wireless communication device 102 is shown. In particular, a control circuit 1102 is coupled to a transmitter 1104 and to a receiver 1106. The transmitter and receiver are coupled to an antenna 108 for transmitting and receiving RF communication signals, as is well known in the art. The wireless communication device 102 preferably includes a digital signal processor (DSP)/application-specific integrated circuit (ASIC) 1110. The DSP/ASIC 1110 is coupled to the transmitter 1104 and the receiver 1106, and is adapted to enable communication of digital signals between the control circuit 1102 and the transmitter 1104 and the receiver 1106. The wireless communication device 102 also preferably includes a local wireless transceiver 1112. The local wireless transceiver 1112 could be any low-power local wireless transceiver which would enable short range communication to another device. The local wireless transceiver 1112 could communicate on any wireless protocol, such as infrared, Bluetooth, IEEE 802.11, or some other local wireless communication protocol. A communication port 1114 is also preferably coupled to the control circuit 1102 to enable a wired communication link to another device, such as another wireless communication device 102 or a different device such as a laptop or desktop computer. The communication port 1114 could enable communication between the devices by way of any wired communication protocol, such as RS-232, or some proprietary protocol.

A global positioning system (GPS) unit 1116 is also preferably coupled to the control circuit 1102 to provide location information to the control circuit. That is, the GPS unit 1114 can provide the location information related to the location of the wireless communication device 102, as is well known in the art. Although a GPS unit is shown, any other circuit or software for providing location information of the wireless communication device 102 could be employed according to the present disclosure. For example, triangulation using base stations in a wireless communication network, as is well known in the art, could be used to provide less accurate location information related to the wireless communication device 102. An application program interface (API) 1118 is also coupled to the control circuit 1102 to provide an application interface, as is well known in the art.

A memory 1120 comprising a picture memory 1121 and a profile 1122 is also preferably coupled to the control circuit. As will become apparent in reference to the remaining figures, various data, such as picture files, information data, and other information could be stored in the picture memory 1121. Similarly, user data could be stored in the profile portion 1122. The user can receive information according to the methods described in U.S. application Ser. No. 60/378,631, entitled METHOD OF AND APPARATUS FOR PROVIDING INFORMATION TO A WIRELESS COMMUNICATION,DEVICE (LF200A—Express Mail No.: EU281037834US) filed by the inventors of the present invention and assigned to the same assignee as the present invention, the entire application of which is incorporated by reference.

Memory 1120 could be incorporated in a single memory device, or a plurality of memory devices, as is well known in the art. In particular, a combination of memory devices, such as a read-only memory (ROM), a random-access memory (RAM), or an EEPROM could be employed, as is well known in the art, depending upon the nature of the information stored in the memory. Although the memory is shown partitioned into a picture memory 121 and a profile portion 1122, such a partitioning is merely shown by way of example, and the memory could be partitioned in any way.

Finally, a user interface 1123 is coupled to the control circuit 1102 to enable a user of the wireless communication device 102 to transmit and receive information with a device by way of a communication network. In particular, a keypad 1123 is coupled to the control circuit 1102 to enable entry of information which can be provided by way of a display driver 1126 to a display 1128, a display 1129, or a display 1130 of the user interface 1123. The keypad could be a numeric keypad having alphanumeric-entry capability, or could be a full QWERTY keypad for easier entry of alphanumeric-characters. As will be described in more detail in reference to other figures, the displays could be positioned at different locations on the wireless communication device. The displays could all be color displays, black and white displays, or a combination of color and black and white. The displays preferably comprise full color liquid crystal displays (LCDs). The displays could be used for displaying information including pictures, text, icons, functional icons, etc. stored in the wireless communication device, downloaded from a wireless communication network, or viewed or captured by the digital camera 1142. The displays could also have a predetermined function, such as displaying text, picture files or a user interface and its associated functional icons. Finally, the displays could represent portions of a single display dedicated to one or more particular functions.

The user interfaces further comprises audio circuitry 1134, which includes a microphone 1136 and a speaker 1138. The control circuit 1102 and audio circuit 1134 also preferably enable voice-activated communication, including voice recognition communication as well as speakerphone capability. Such voice recognition circuitry and/or software could be employed in the wireless communication device or at the service provider. Finally, a memory card 1140, such as a compact flash card or multimedia memory card, would enable the storage of one or more picture files or other information taken by a digital camera 1142 having a lens on the camera or stored in the memory 1120, or provided to control circuit 1102 for display or downloaded to the memory 1120 for later display. Although an exemplary wireless communication device 102 is shown, the features and functions of the wireless communication device 102 could be employed in other functional arrangements, or by other functional blocks which are well known in the art. The wireless communication device 102 as shown in FIG. 1 is merely an exemplary device showing the fundamental features of a wireless communication device employing the features and functions described in the present disclosure. The wireless communication devices and methods described in U.S. application Ser. No. 60/389,814, entitled METHOD OF AND APPARATUS FOR DISPLAYING INFORMATION ON A WIRELESS COMMUNICATION DEVICE (LF300A Express Mail No.: EU280923228US) filed by the inventors of the present invention and assigned to the same assignee as the present invention, the entire application of which is incorporated by reference, could incorporate the circuits or features of the present invention.

Turning now to FIG. 12, a block diagram of printing equipment 200 is shown. In particular, a control circuit 1202 is coupled to a transmitter 1204 and to a receiver 1206. The transmitter and receiver are coupled to an antenna 1208 for transmitting and receiving RF communication signals, as is well known in the art. The printing equipment 200 preferably includes a digital signal processor (DSP)/application-specific integrated circuit (ASIC) 1210. The DSP/ASIC 1210 is coupled to the transmitter 1204 and the receiver 1206, and is adapted to enable communication of digital signals between the control circuit 1202 and the transmitter 1204 and the receiver 1206. The printing equipment 200 also preferably includes a local wireless transceiver 1212. The local wireless transceiver 1212 could be any low-power local wireless transceiver which would enable short range communication to another device. The local wireless transceiver 1212 could communicate on any wireless protocol, such as infrared, Bluetooth, IEEE 802.11, or some other local wireless communication protocol. A communication port 1214 is also preferably coupled to the control circuit 1202 to enable a wired communication link to another device, such the wireless communication device 102. The communication port, 1214 could enable communication between the devices by way of any wired communication protocol, such as RS-232, or some proprietary protocol. The printing equipment 200 also preferably includes a modem 1216 to enable communication with a landline communication network, such as the landline communication network 130. An application program interface (API) 1218 is also coupled to the control circuit 1202 to provide an application interface, as is well known in the art.

A memory 1220 is also preferably coupled to the control circuit. Memory 1220 could be incorporated in a single memory device, or a plurality of memory devices, as is well known in the art. In particular, a combination of memory devices, such as a read-only memory (ROM), a random-access memory (RAM), or an EEPROM could be employed, as is well known in the art, depending upon the nature of the information stored in the memory.

Finally, a user interface 1223 is coupled to the control circuit 1202 to enable a user of the wireless communication device 102 to transmit information to and receive information from the printing equipment 200. In particular, a keypad 1223 is coupled to the control circuit 1202 to enable entry of information which can be provided by way of a display driver 1226 to a display 1228 of the user interface 1223. The keypad could be a numeric keypad having alphanumeric-entry capability, or could be a full QWERTY keypad for easier entry of alphanumeric characters. The display could be used for displaying information including pictures, text, icons, functional icons, etc. stored in the wireless communication device, or viewed or captured by the digital camera 1142, and could be a touchscreen display to provide a user interface for the printing equipment.

The user interfaces further comprises audio circuitry 1234, which includes a microphone 1236 and a speaker 1238. The control circuit 1202 and audio circuit 1234 also preferably enable voice-activated communication, including voice recognition communication as well as speakerphone capability. Finally, a memory card slot 1240 for receiving the memory card 1140, such as a compact flash card or multimedia memory card, would enable the downloading of one or more picture files or other information taken by a digital camera 1142 having a lens on the camera or stored in the memory 1120. Finally, the printing equipment 200 comprises a printing circuit 1242 coupled to receive paper and ink, and generate a printed picture based upon a picture file at an output 1244. Although an exemplary printing equipment 200 is shown, the features and functions of the printing equipment could be employed in other functional arrangements, or by other functional blocks which are well known in the art. The printing equipment, 200 as shown in FIG. 12 is merely an exemplary device showing the fundamental features of printing equipment employing the features and functions described in the present disclosure.

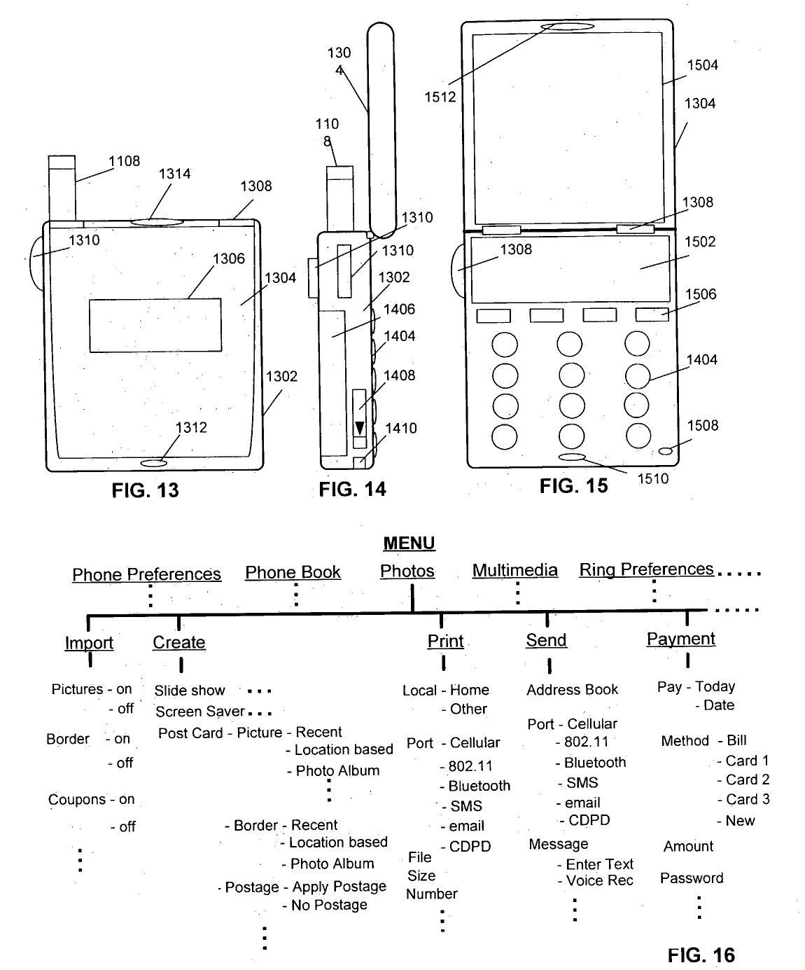

Turning now to FIGS. 13-15, an exemplary wireless communication device 102 is shown. As shown in FIG. 13, a top plan view of the wireless communication device when closed according to the present invention is shown. In particular, in first body portion 1302 is coupled to a second body portion 1304 having an outer display, 1306. The first body portion is coupled to the second body portion by a hinge 1308. A user interface actuator 1310 is preferably positioned on the side of the first body portion 1302. A microphone 1312 and a speaker 1314 on the lower body portion are visible when the wireless communication device is closed. As shown in FIG. 14, a side view of the wireless communication device of FIG. 13 exposes a keypad 1404 when the second; body portion is moved from a first position to a second position. Also shown on the side of the first body portion 1302 is a battery 1406, and eject button 1408 for ejecting a memory card, such as the memory card 1140, from a slot 1410. Finally as shown in the top plan view of the wireless communication device of FIG. 13, a first display 1502 on the first portion 1302 and a second display 1504 on the second portion 1304 are visible. The keypad 1404 preferably comprises a user interface 1506 having a plurality of actuator keys. A power button 1508, a microphone 1510, and a second speaker 1512 are also visible.

Turning now to FIG. 16, a tree diagram shows an example of a portion of a photo menu according to the present invention. The tree diagram of FIG. 16 shows a variety of options for manipulating photos taken or received by the wireless communication device 100 to according to the present invention. In particular, when selecting the photos option on the wireless communication device 102, a user could select to set preferences related to importing photos to the wireless communication device. For example, the user could set preferences allowing or preventing the receipt of certain wireless data files such as pictures, borders, coupons, etc. More particularly, because some of the files could be broadcast wirelessly when a wireless communication device is within range of a photographer, a user may decide to prevent the wireless transmission of certain data. Alternatively, the user may decide that they desired to receive such data as borders or coupons. When employed in a special setting such as an amusement park, a photographer may take a picture, and download the picture with an appropriate border which can optionally be applied by the user when the picture is printed. The user may also desire to receive coupons to have the picture developed at a location at or near the amusement park.

The user may also desire to create a particular file which is an altered version of an original picture file or a plurality of picture files. As shown in FIG. 16, the user can opt to create a slide show, a screensaver, or postcard. The creation of a slide show and screensaver are shown in the Applicants co-pending application LF300A, already incorporated by reference herein. However, according to one unique feature the present invention, a user of the wireless communication device 102 can create a postcard which can be printed by a printer. In particular, the user could select a picture from a variety of locations stored in memory, including recently downloaded pictures, location based on pictures, or other photo albums or directories containing pictures stored on the wireless communication device 102. The user could also select a border to be printed on the postcard surrounding the picture. The border could be, for example, a white border, or a theme border, such as a logo associated with an amusement park or other location associated with the picture. The user can also search locations in memory to find a border. Finally, the user would preferably have the option of selecting whether postage would be applied to the postcard when printed. If the user did not having to have stamps available, the user could request the postage be applied, and be billed accordingly.

The user may also have an option to select to print a picture file or other file created on the wireless communication device 102. The user would have the option of selecting a printer, such as a home printer or a local printer which is within range of the wireless communication device 102. Alternatively, the user could select to print the file to a remote printer accessible by a wide area network available to the wireless communication device 102. The user could preferably choose a port for transmitting a file. Finally, the user would preferably have the option of selecting the file, the size of the output to be printed, the number of copies to printed, etc. The user would also preferably have an option of sending a file to another wireless communication device or computer at a particular address. The user would have the option of selecting an address from an address book or other location, as well as a port for transmitting the file. The user would preferably have an option of entering a message associated with the file. Preferably the user would have the option of selecting whether to enter a text message on a keypad of the wireless communication device, or dictating a message which would be transcribed by voice recognition software on the wireless communication device, or associated with the service provider providing wireless communication service to the device.

Finally, the user would have the option to make a payment directly from the wireless communication device to a third party, such as a photographer printer. The user would preferably have the option to select the time of payment, the method of payment, the amount of the payment, etc. The wireless communication device would preferably include locations within memory to store information related to credit cards to enable an electronic payment. The wireless communication device would preferably require a password to make the appropriate payment. The payment could be made wirelessly by a local wireless connection, or a wide area connection. Alternatively, the payment could be made from the wireless communication device by a wired connection, such as an RS-232 connection. Although various elements of the photo menu are shown, is contemplated that other elements or features could be incorporated in the photo menu. It is further contemplated that the photo menu is merely a small portion of the entire menu for the wireless communication device.

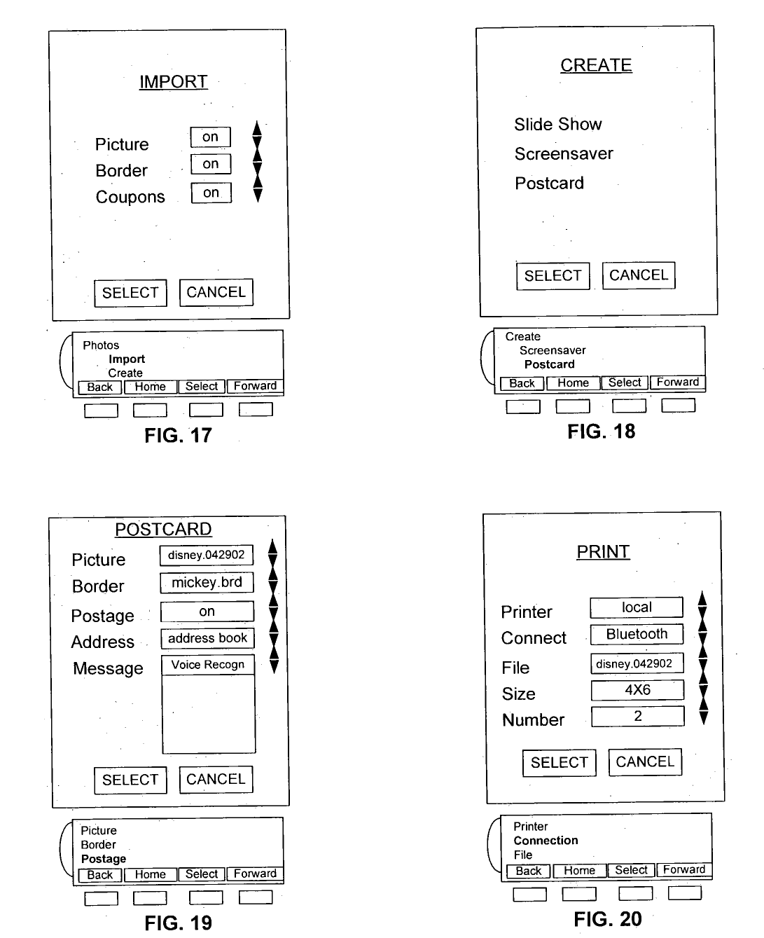

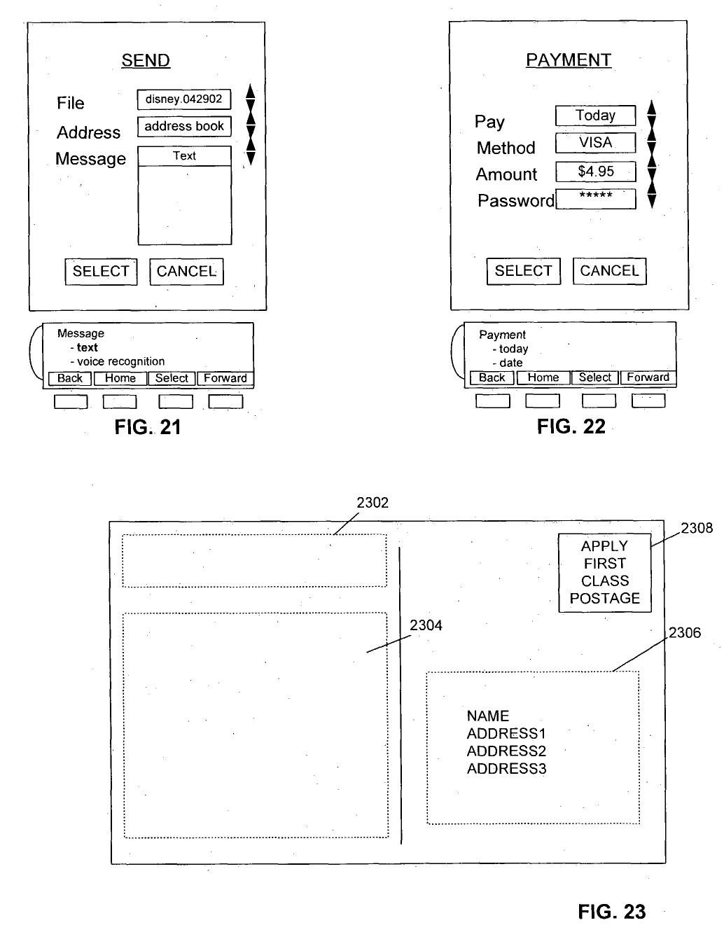

Turning now to FIGS. 17-22, exemplary displays for employing the photos option on the wireless communication device 102 are shown. Referring specifically to FIG. 17, an example of a display of a wireless communication device shows an import feature according to the present invention. The various selections for picture, borders, and coupons are shown, while the arrows adjacent to be boxes would enable a user to change a selection on a touch screen display. Alternatively, a user could employee a user interface associated with the lower display having the actuator key 1308 and the user actuator keypad 1506 to cursor through the menu and make selections if no touch screen is available. It is also contemplated that the lower display could be a touch screen display.

The user interface associated with the lower display as shown throughout FIGS. 17-22 could also em ploy the use of softkeys associated with the user actuator keypad 1506. The currently selected menu option, which is displayed in the upper screen, is highlighted in the lower screen. By selecting that menu option again, further options would then be displayed. For example, by selecting the import option again, the picture, border, and coupons options would be shown in the lower display, enabling the user to select those options and change any preferences as desired. The various options associated with the softkeys would enable the user to continue to navigate through the menu.

Turning now to FIG. 18, an example of a display of a wireless communication device shows a create feature according to the present invention. By selecting the postcard feature, which are shown highlighted in the lower display, the options for creating a postcard would be displayed in the upper display, a shown in FIG. 19. As described above, the upper display could be a touch screen display, or the selections can be made using the lower display and appropriate user interface. Finally, example displays showing print, send, and payment features are shown in FIGS. 20-22.

Turning now to FIG. 23, an example of a postcard generated according to the present invention is shown. In particular, a field 2302 could include a standard language related to the background of the picture on the postcard. For example, if the picture on the postcard were taken at a particular scene at an amusement park, text could be printed in field 2302 describing the location. The postcard would also preferably include a message field 2304. The message field would preferably be entered by the user as shown in FIG. 19. That is, the message could be entered by voice recognition by the user creating the postcard, and printed in the field 2304 when the postcard is printed. Similarly, the postcard would include an address field 2306. The address field would also be entered when creating the postcard, shown in FIG. 19. Particularly, the wireless communication device would enable easy access to addresses from an address book or manual entry by a user. Finally, the user would have the option of applying postage, or paying the printer for postage and having the postage printed directly on the postcard in the field 2308. The picture and any selected borders would be printed on the reverse side of the postcard of FIG. 23.

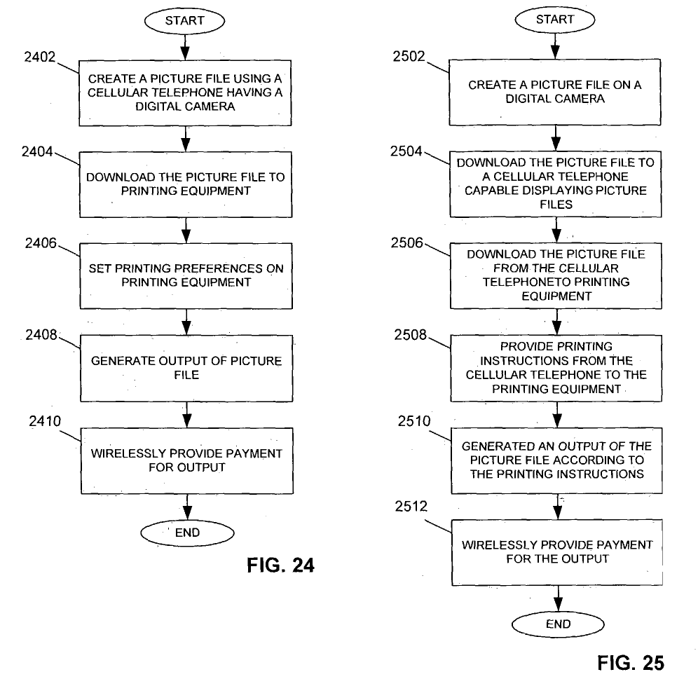

Turning now to FIGS. 24-38, methods for outputting and/or printing and a picture file according to the present invention are shown. It is contemplated that these methods could be employed on any of the devices or networks described herein, or in any other suitable device or network. Turning first to FIG. 24, a flowchart shows a method of outputting a picture file from a wireless communication device such as 80 cellular telephone according to the present invention. In particular, a picture file is created using a cellular telephone having a digital camera at a step 2402. The picture file is downloaded to printing equipment at a step 2404. Printing preferences are sent on the printing equipment at a step 2406. An output of the picture file is generated as a photograph at a step 2408. Finally, payment for the output is provider wirelessly by the cellular telephone to the printing equipment at a step 2410.

Turning now to FIG. 25, a flowchart shows a method of outputting a picture file from a digital camera according to an alternate embodiment of the present invention. In particular, a picture file is created on a digital camera at a step 2502. The picture file is downloaded to a cellular telephone capable display picture files at a step 2504. The picture file is then downloaded from the cellular telephone to printing equipment at a step 2506. Printing instructions are also provided from the cellular telephone to the printing equipment at a step 2508. The printing instructions could be, for example, the selections in the print options shown in FIG. 20. An output of the picture file is then generated according to the printing instructions at a step 2510. Finally, a wireless payment is provided for the output at a step 2512.

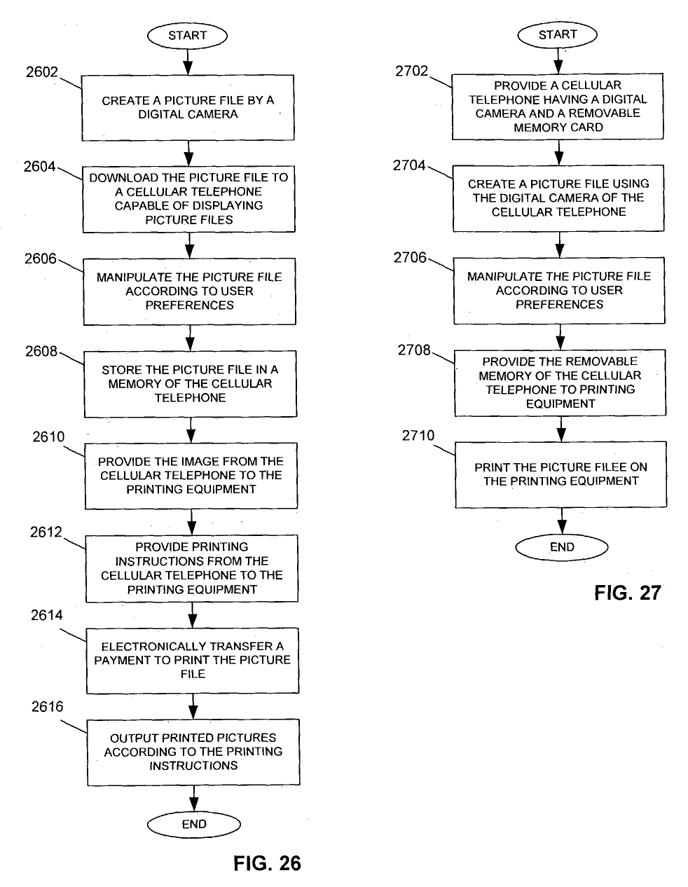

Turning now to FIG. 26, a flowchart shows a method of outputting a picture file and printing instructions to printing equipment according to an alternate embodiment of the present invention. A picture file is created by digital camera at a step 2602. The picture file is downloaded to cellular telephone capable display the picture file at a step 2604. The picture file is manipulated according to user preferences at a step 2606. The picture file is then stored in a memory of the cellular telephone at a step 2608. The picture file is then provided from the cellular telephone to printing equipment at a step 2610. Printing instructions are also preferably provided from the cellular telephone to the printing equipment at a step 2612. Any payment to print the picture file is then electronically transferred from the cellular telephone to the printing equipment at a step 2614. Finally, printed pictures are output according to the printing instructions at a step 2616.

Turning now to FIG. 27, a flowchart shows a method of outputting a picture file by way of a removable memory according to an alternate embodiment of the present invention. A cellular telephone having a digital camera and a removable memory card are provided at a step 2702. A picture file is then created using the digital camera of the cellular telephone at a step 2704. The picture file is manipulated according to user preferences at a step 2706. The removable memory is then provided to the printing equipment at a step 2708. The picture file is then printed on the printing equipment at a step 2710.

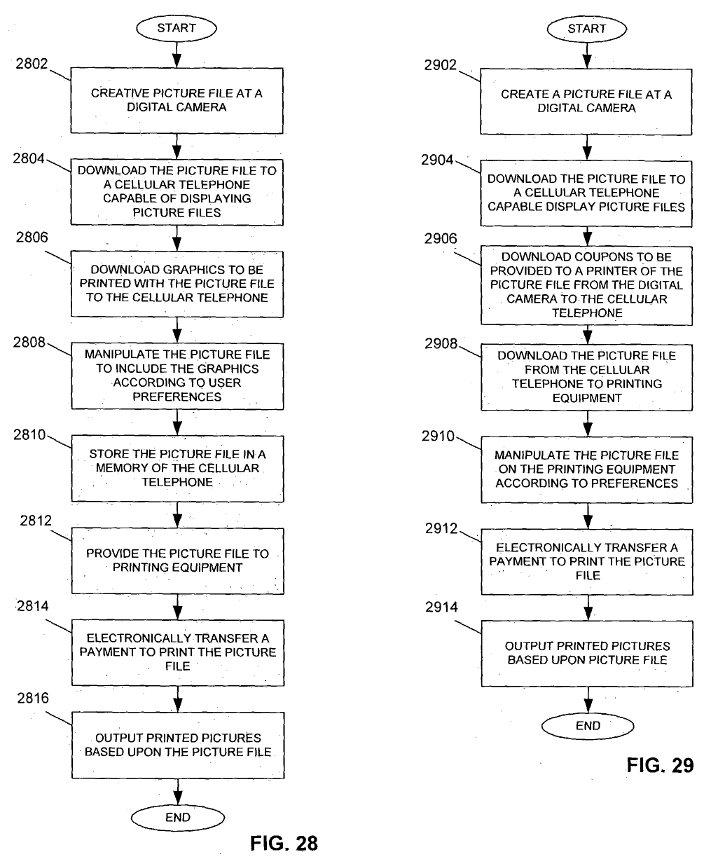

Turning now to FIG. 28, a flowchart shows a method of outputting a picture file and graphics according to an alternate embodiment of the present invention. A picture file is created at a digital cam, era at a step 2802. The picture file is then downloaded to cellular telephone capable of display picture files at a step 2804. Graphics to be printed with the picture file are then provided to the cellular telephone at a step 2806. The picture file is then manipulated to include the graphics according to user preferences at a step 2808. The picture file is then stored in a memory of the cellular telephone at a step 2810. The picture files then provided to printing equipment at a step 2812. An electronic payment is then preferably transferred to the printing equipment to print the picture file at a step 2814. Finally, an outputted printed picture is then provided based on the picture file at a step 2816.

Turning now to FIG. 29, a flowchart shows a method of outputting a picture file associated with a coupon according to an alternate embodiment of the present invention according to the present invention. A picture file is created at a digital camera at a step 2902. The picture file is then downloaded to cellular telephone capable display picture files at a step 2904. Coupons are also preferably downloaded from the digital camera to the cellular telephone at a step 2906. The picture file is then downloaded from the cellular telephone to printing equipment at a step 2908. The picture file is manipulated on the printing equipment by a user at a step 2910. A payment is then electronically transferred to the printing equipment to print the picture file at a step 2912. Finally, the printed picture is output at a step 2914.

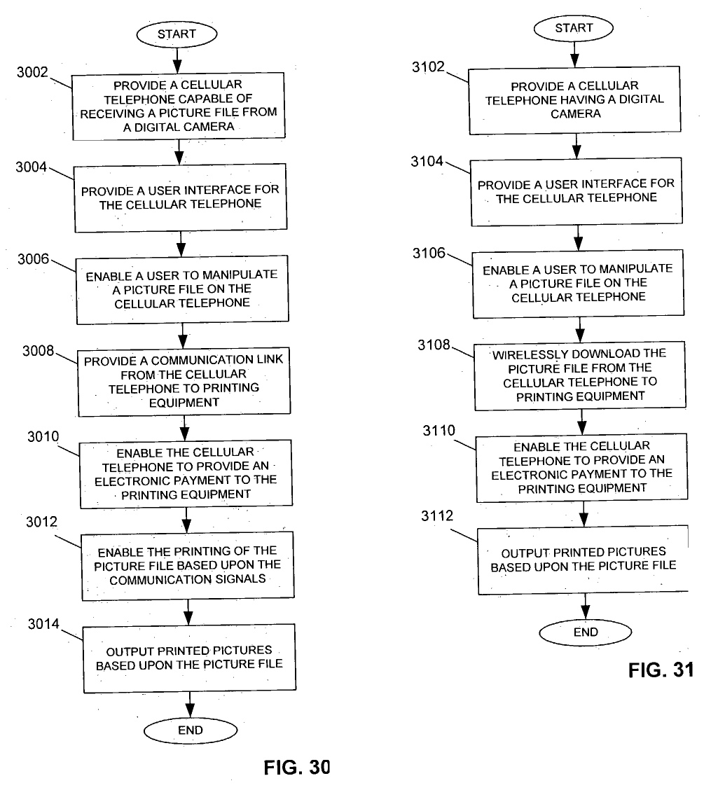

Turning now to FIG. 30, a flowchart shows a method of outputting a picture file manipulated on a cellular telephone according to an alternate embodiment of the present invention. In particular, a cellular telephone capable of receiving a picture file from a digital camera is provided at a step 3002. A user interface is provided to a cellular telephone at a step 3004. A user can then manipulate the picture file on the cellular telephone at a step 3006. A communication link is provided from the cellular telephone to printing equipment at a step 3008. The cellular telephone then provides an electronic payment to the printing equipment at a step 3010. The picture file is then printed based on signals transmitted over the communication link at a step 3012. Finally, the picture file is are output at a step 3014.

Turning now to FIG. 31, a flowchart shows a method of outputting a picture file taken by and manipulated on a cellular telephone according an alternate embodiment of the present invention. A cellular telephone having a digital camera is provided at a step 3104. A user interface is also provided in the cellular telephone at a step 3104. The user interface enables a user to manipulate the picture file on the cellular telephone at a step 3106. The picture file is then wirelessly downloaded from the cellular telephone to printing equipment at a step 3108. The cellular telephone then provides an electronic payment to the printing equipment at a step 3110. Finally, print pictures are output at a step 3112.

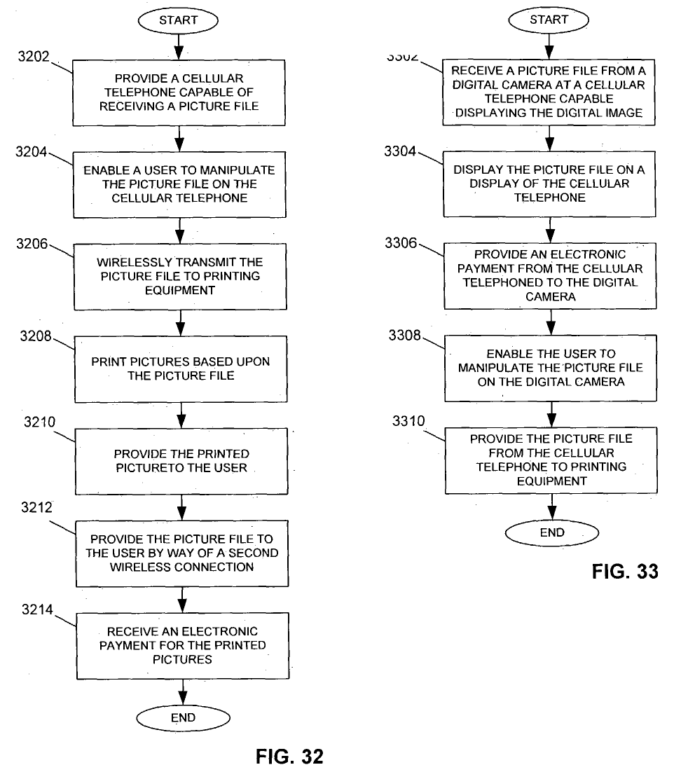

Turning now to FIG. 32, a flowchart shows a method of outputting a picture file wirelessly transmitted to printing equipment according to an alternate embodiment of the present invention. A cellular telephone capable of receiving a picture file is provided at a step 3202. A user can then manipulate the picture file on the cellular telephone at a step 3204. The picture file is then wirelessly transmitted to printing equipment at a step 3206. Pictures based upon the picture file are then printed at a step 3208. The printed pictures are provided to the user at a step 3210. The picture files then provided to the user by way of a second wireless connection at a step 3212. For example, the picture file could be downloaded to a user file associated with a particular service, such as they web site associated with the printing service. Preferably, the user would have access to the web site to access is pictures at a later time. Finally, the printer would send an electronic payment from the wireless communication device for the printed pictures at a step 3214.

Turning now to FIG. 33, a flowchart shows a method of outputting a picture file provided from a digital camera to a cellular telephone according to an alternate embodiment of the present invention. A picture file is received from a digital camera at a cellular telephone capable of displaying a picture file at a step 3302. The picture file is displayed on the display of the cellular telephone at a step 3304. An electronic payment is provided from the cellular telephone to the digital camera at a step 3306. The user is then able to manipulate the picture file on the digital camera at a step 3308. Finally, the picture files provided from the cellular telephone to printing equipment at a step 3310.

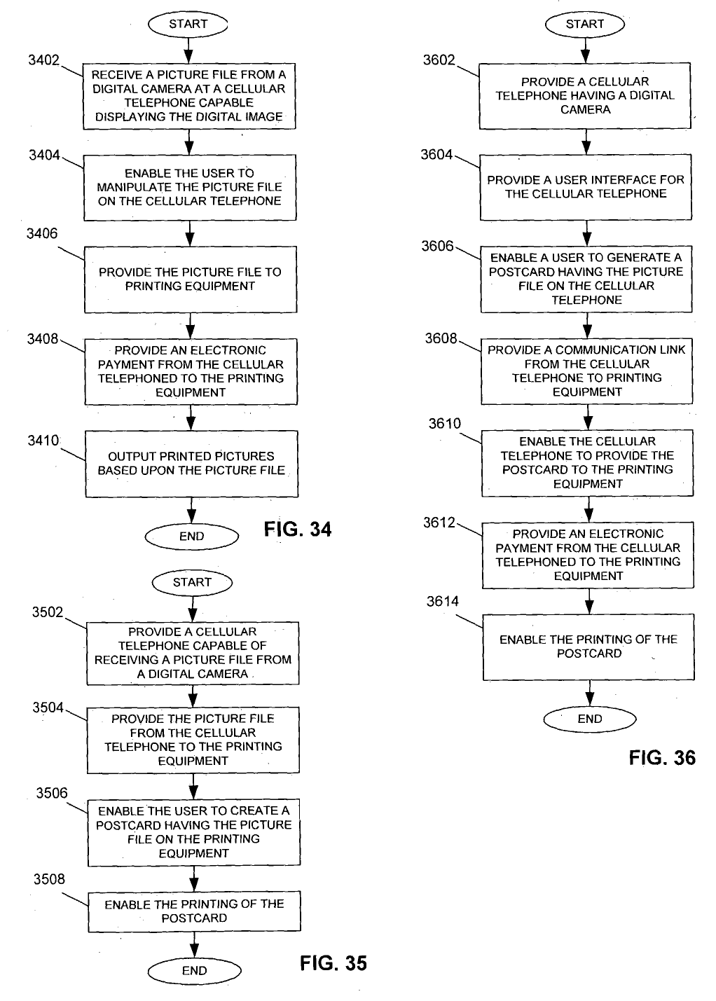

Turning now to FIG. 34, a flowchart shows a method of outputting a picture file for which a payment was provided to printing equipment according to an alternate embodiment of the present invention. A picture file from a digital camera is received a cellular telephone cable of displaying a picture file at a step 3402. The user is then able to manipulate the picture file on the cellular telephone at a step 3404. The picture file is then provided to be printing equipment at a step 3406. An electronic payment is then provided from the cellular telephone to the printing equipment at a step 3408. Finally, print pictures based upon the picture file are then output at a step 3410.

Turning now to FIG. 35, a flowchart shows a method of outputting a picture file printed on a postcard according to an alternate embodiment of the present invention. A cellular telephone capable of receiving a picture file from a digital camera is provided at a step 3502. The picture file is provided from the cellular telephone to the printing equipment at a step 3504. The user then creates a postcard having the picture file on the printing equipment at a step 3506. That is, the user can use the printing equipment to create a postcard having the picture file. The postcard is then print at a step 3508.

Turning now to FIG. 36, a flowchart shows a method of outputting a picture file on a postcard generated on a cellular telephone according to an alternate embodiment of the present invention. A cellular telephone having a digital camera is provided at a step 3602. A user interface is provided for the cellular telephone at a step 3604. A user can generate a postcard having the picture file on the cellular telephone at a step 3606. That is, the user can use the user interface and display of the cellular telephone to create a postcard. A communication link is provided from the cellular telephone to printing equipment at a step 3608. The cellular telephone then provides the postcard to printing equipment at a step 3610. Electronic payment is then made from the cellular telephone to printing equipment at a step 3612. The postcard is then print at a step 3614.

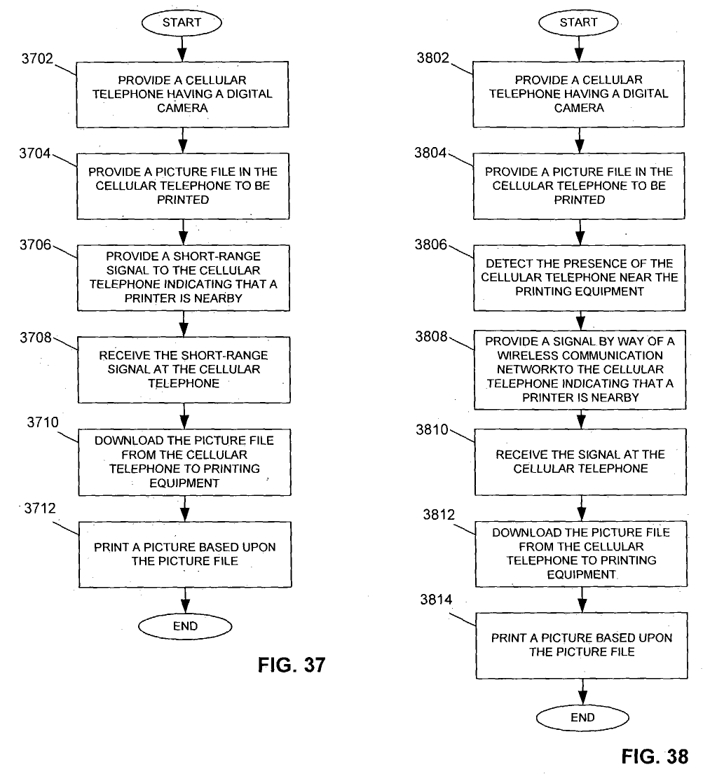

Turning now to FIG. 37, a flowchart shows a method of outputting a picture file in response to a short range signal provided to a cellular telephone according to an alternate embodiment of the present invention. A cellular telephone having a digital camera is provided at a step 372. A picture file is created in the cellular telephone at a step 3704. A short range signal is provided to the cellular telephone indicating their printers nearby at a step 3706. The short range signal is received at the cellular telephone at a step 3708. The picture file is, downloaded from the cellular telephone the printing equipment at a step 3710, and the picture is printed at a step 3712.

Finally, turning now to FIG. 38, a flowchart shows a method of outputting a picture file in response to a signal from a wireless communication network according to an alternate embodiment of the present invention. A cellular telephone having a digital camera is provided at a step 3802. A picture file is created by the cellular telephone at a step 3804. The presence of the cellular telephone is detected into the printing equipment at a step 3806. For example, the location of the cellular telephone could be provided from the cellular service provider to the printer based upon a GPS location of the cellular telephone. Signals are provided by way of the wireless communication device to the cellular telephone indicating their printers nearby at a step 3806. Such signals can include advertisements, directions, etc. The signals are received at the cellular telephone at a step 3810. The picture file is then downloaded from the cellular telephone to the printing equipment at a step 3812 and a picture is printed at a step 3814.

In summary, the present disclosure relates to method and apparatus for outputting and/or printing a picture file using a cellular telephone or other wireless communication device to the. The methods, systems, and devices described herein find application in a variety of settings. For example, the methods could be employed in a conventional urban environment where a user of a wireless communication device could interact with a photographer and/or printer. Alternatively, the methods could be employed in a special setting, such as an amusement park. The foregoing discussion of the invention has been presented for purpose of illustration and description. Further, the description is not to limit the invention to the form disclosed herein. Consequently, variations and modifications commensurate with the above teachings within the skill and knowledge of the relevant art, are within the scope of the present invention. The embodiments discussed hereinabove are further intended to explain the best mode known of the invention and to enable others skilled in the art to utilize the invention in such, or in other, embodiments and with the various modification required by their application or uses of the invention. It is intended that the any claims to an invention be constructed to include alternative embodiments to the extent permitted by the prior art.

We claim:

1. A cellular telephone capable of transmitting a picture, said cellular telephone comprising:
a digital camera capturing said picture;
a control circuit coupled to said digital camera, said control circuit enabling the storage of said picture;
a memory coupled to said control circuit; and
a border stored in memory, said border being applied to said picture to surround said picture.

2. The cellular telephone of claim 1 further comprising a receiver coupled to said control circuit, said receiver coupling said border from a remote location to said cellular telephone.

3. The cellular telephone of claim 1 further comprising a plurality of borders.

4. The cellular telephone of claim 3 further comprising a user interface for enabling the selection of a border receiver of said plurality of borders.

5. The cellular telephone of claim 1 further comprising a transmitter coupled to said control circuit, said transmitter capable of sending said picture and said border.

6. A cellular telephone capable of transmitting a picture, said cellular telephone comprising:
a digital camera for capturing said picture;
a control circuit coupled to said digital camera, said control circuit enabling the storage of said picture; and
a user interface coupled to said control circuit, said user interface enabling the selection of a border to surround said picture.

7. The cellular telephone of claim 7 further comprising a memory storing a plurality of borders.

8. The cellular telephone of claim 6 wherein said user interface enables selecting an address to send said picture and said border.

9. The cellular telephone of claim 8 wherein said user interface enables entry of a message with said picture file.

10. The cellular telephone of claim 9 further comprising a transmitter for transmitting said picture file and border to said address.

11. A cellular telephone capable of transmitting a picture, said cellular telephone comprising:
a digital camera for capturing said picture;
a control circuit coupled to said digital camera, said control circuit enabling the storage of said picture;
a user interface coupled to said control circuit, said user interface having a keypad enabling the selection of a border; and
a transmitter sending said picture and said border by way of a wireless communication network.

12. The cellular telephone of claim 11 further comprising a receiver coupled to said control circuit, said receiver receiving a border.

13. The cellular telephone of claim 12 wherein said border comprises a location specific border.

14. The cellular telephone of claim 11 further comprising a plurality of borders stored in said memory.

15. The cellular telephone of claim 11 further comprising a voice recognition circuit.

16. A method of displaying a picture on a cellular telephone, said method comprising the steps of:
providing a digital camera on said cellular telephone for capturing a picture;
storing a border in a memory of said cellular telephone; and
coupling a border to a picture.

17. The method of claim 16 further comprising a step of receiving said border.

18. The method of claim 16 further comprising a step of enabling a user of said cellular telephone to select a border of a plurality of borders.

19. The method of claim 16 further comprising a step of transmitting said picture and said border.

20. The method of claim 19 wherein said step of transmitting comprises transmitting said picture and said border to a printer to be printed as a postcard.

21. A method of displaying a picture on a cellular telephone, said method comprising the steps of:
providing a digital camera on said cellular telephone for capturing a picture;
storing a plurality of borders in a memory of said cellular telephone;
enabling the selection of a border of said plurality of borders; and
coupling a picture file with said selected border.

22. The method of claim 21 further comprising a step of receiving a border by way of a wireless communication network.

23. The method of claim 21 further comprising a step of selecting an address.

24. The method of claim 23 wherein said step of transmitting comprises transmitting said border and said address to a printer.

25. The method of claim 24 comprising a step of printing said picture, said border and said address as a postcard.
